(19) United States
(12) Patent Application Publication
(10) Pub. No.: US 2017/0007865 A1
(43) Pub. Date: Jan. 12, 2017

(54) Intelligent Method of Protecting Forest and Brush from Fire

(71) Applicants: David DOR-EL, Los Angeles, CA (US); Itzhak Shalev, Bet Gamliel (IL)

(72) Inventors: David DOR-EL, Los Angeles, CA (US); Itzhak Shalev, Bet Gamliel (IL)

(21) Appl. No.: 14/797,129

(22) Filed: Jul. 12, 2015

(51) Int. Cl. A62C 3/02; F42B 12/50

(52) U.S. Cl. CPC A62C 3/025; A62C 3/0271; F42B 12/50

(57) ABSTRACT

An intelligent method of fighting a forest or brush fire in a remote area including the steps of targeting the remote area by means of an aerial surveillance device and generating a map of the forest or brush fire. The method also includes the step of delivering a plurality of containers to the remote area. Each container contains a fire retardant material and an explosive device. Each of container has a GPS locating device. a position transmitting device and a remote detonating device electronically coupled to the explosive device. The method further includes the steps of locating the position of each container, selecting according to a plan which of the containers are to be selected to be detonated and remotely detonating the selected containers. The forest or brush fire can be either extinguished or contained in an intelligent manner. An individual generates the plan according to which of said containers are to be selected to be detonated in order to maximize effectiveness of said intelligent method.

### BACKGROUND OF THE INVENTION

Field of the Invention

The present invention generally relates to relates to an intelligent method for protecting forest and brush from a fire in. The present invention relates to fire protection methods, and related deployment methods. In particular, the invention relates to deployment methods used for containing a forest fire having a relatively large expanse.

Description of the Prior Art

U.S. Pat. No. 7,261,165 teaches a housing unit which includes two parts that define a fire-smothering chemical storing interior volume. The housing unit is transported to a target area of a forest fire by an aircraft and dropped onto the target area. An explosive charge is located inside the housing unit and is detonated when the housing unit impacts the ground. The explosion associated with the detonated charge separates the two parts of the housing and disperses the chemical from the open housing unit.

U.S. Pat. No. 8,746,355 teaches a fire-extinguishing bomb that can be pre-programmed to explode 2-200 feet above the ground or tree line. The bomb employs a laser or barometric altitude sensor in combination with a GPS-altitude sensor for failsafe detonation with extreme accuracy at the proper altitude. The redundant failsafe altitude-dependent detonation system ruptures a container carrying a payload of wet or dry fire retardant/suppressant, dry environmentally-friendly fire-retardant powder having no toxicity and having fertilizer properties. Upon detonation the device coats the ground below with a uniform fire extinguishing coating. The core components of the bomb can be biodegradable, or alternatively can be readily retrieved and reused after each activation, thereby increasing both economy and reducing environmental concerns.

U.S. Patent Publication No. 2004/0238186 teaches a fire-fighting apparatus for fighting a fire having a relatively large area or volume. The apparatus includes a targeting system for identifying a target area to be doused with fire retardant and an ordnance for discharging a multiplicity of projectiles having the fire retardant contained therein. The ordnance of the apparatus includes at least one barrel assembly which has a barrel, a plurality of projectiles axially disposed within the barrel for operative sealing engagement with the bore of the barrel, and discrete propellant charges for propelling respective projectiles sequentially through the muzzle of the barrel, whereby the fire retardant is dispersed over the target area or within the target volume.

Fires which extend over a large expanse, in either two dimensions such as a grass fire or three dimensions such as in a bush or forest fire, industrial or chemical fires or a multi-story building, present particular problems in regard to delivering fire retardant or dousing materials quickly and precisely over threatened areas, whilst minimizing risks for fire fighters and surrounding assets.

Conventional fire-fighting techniques typically involve controlling progress of an expansive fire at a perimeter, which may involve back burning. Back burning operations also involve inherent risk, especially in the case of a change in the direction of prevailing winds.

It is also known to use airborne delivery of fire suppressants wherein suppressant material is dropped into a fire from above by water bombing by fixed or rotary wing aircraft. This is a relatively costly technique requiring special purpose aircraft and skilled pilots for maximum effect.

Furthermore, the presence of toxic fumes or other by-products of industrial or chemical fires, together with the possibility of explosions and debris propelled by such explosions, may pose additional risks to those fighting fires, not to mention other persons and fixed assets in the vicinity. Accordingly, it is highly desirable that such fires be fought from a relatively safe distance.

U.S. Pat. No. 3,762,478 teaches a remote controlled hazard-fighting vehicle including a chassis having crawler tracks mounted on opposite sides thereof. Motors are mounted within the chassis for independently advancing the crawler tracks. A movable turret is mounted on the upper part of the chassis and includes a movable nozzle for being attached through a flexible hose to a source of pressurized fluid. A portable transmitter is provided to selectively generate a plurality of unique tone signal combinations. A receiver is mounted within the chassis for receiving the tone signal combinations, and circuitry within the chassis is responsive to the output of the receiver in order to control the advancement of the crawler tracks and the movement of the turret and nozzle.

U.S. Pat. No. 3,169,581 teaches a plurality of vehicles operated through cables for applying various fire-fighting agents to fires. It has been found that the use of such cables presents problems because of the vulnerability of the cables to fouling or to severance by the vehicle wheels and protuberances from the ground. In addition, the use of such cables limits the distance which an operator may stand away from the fire or other catastrophe. Moreover, prior art fire-fighting devices have not been sufficiently versatile or reliable for widespread practical use for hazard-fighting applications. A need has thus arisen for a rugged remote controlled hazard-fighting vehicle which may be directed into close proximity of a fire or other catastrophe without being hampered by ice, boggy ground, high winds, ground embankments, radiation, intense heat, noxious or chemical fumes, hostile crowds, or the danger of explosions.

U.S. Pat. No. 6,796,382 teaches a fire extinguishing device for use in interior or localized exterior conflagrations. The force of detonation of the fire extinguishing device is minimalized through the use of low density/low mass components; no part of the device having sufficient mass or density to typically constitute a safety hazard as flying debris, nor be dangerous in concussive shock due the explosive burst. The present invention is composed of a lightweight casing of rigid plastic foam or other suitably frangible material, with an abrasion-resistant, thin plastic, protective, exterior sheathing. Within the internal cavity of the device, a low explosive yield detonator is located at or near the center of mass, and is actuated by fuse cord(s) extending from the detonator, the end(s) of which extend(s) from the interior detonator to a mounting at or near the exterior surface. The interior volume of the hollow casing is chargeable, through variations in internal configuration, with a variety of fire-retardant chemical agents, including dry powders, two-part reactants, liquid components or others, singly or in combination.

Fire-fighting devices in general use at present, are subject to numerous limiting factors with respect to their cost of acquisition, placement, storage, deployment for fire-fighting—or fire suppression—and other factors. By their nature, they may require periodic inspection by qualified, knowledgeable persons, training or esoterically detailed familiarity in their use, are typically bulky and/or require, as centralized sensing and extinguishing systems, extensive, expensive installation to afford the protection they are designed to provide. Small fire safety devices, such as the common pressurized dry chemical extinguisher, are relatively heavy, due to the prerequisite construction of their pressurized containers. Their weight, bulk and relative complexity, adds to the cost of manufacture, and therefore, theoretically, their cost of acquisition. In use, their directed stream of chemical spray requires judgment and forethought, and therefore, a fully conscious and cognizant user whose mental faculties have not been impaired by smoke, heat, mental stress or panic.

U.S. Patent Publication No. 2013/0264509 teaches a formulation material which is useful in forestry fire-fighting and which includes (a) an anhydride copolymer having a structural formula wherein a functional group X of the formula is at least one alkyl group selected from the family consisting of methyl, ethyl, and propyl groups! and (b) at least 0.1%, by weight, of at least one cross-linking agent for the anhydride copolymer, the agent selected from the group of cross-linking agents consisting of a biopolymer and a tannin, wherein a weight ratio of the anhydride copolymer to the cross-linking agent is at least 2:1, and wherein a total weight of the anhydride copolymer and the cross-linking agent, within the formulation, is at least 25% on an anhydrous basis.

Fire is the rapid oxidation of a material in the chemical process of combustion, releasing heat, light, and various reaction products. Fires start when a flammable and/or a combustible material, in combination with a sufficient quantity of an oxidizer such as oxygen gas or another oxygen-rich compound, is exposed to a source of heat or ambient temperature above the flash point for the fuel/oxidizer mix, and is able to sustain a rate of rapid oxidation that produces a chain reaction. Forest fires are uncontrolled fires occurring in combustible vegetation. A forest fire differ from other fires by its extensive size, the speed at which it can spread from its original source, its potential to change direction unexpectedly, and its ability to jump gaps such as roads and rivers. Water is currently the most frequently used fire-fighting medium. The extinguishing properties of water are based mainly on its effect in cooling the combustible material to a temperature below the ignition point of the material, by absorbing heat through conversion of water to water vapor. Use of water as an extinguishing agent has a number of disadvantages. For example, during the extinguishing process, large quantities evaporate or flow away unused and may cause unnecessary water damage. Use of water is particularly disadvantageous in fighting forest fires, because such fires are frequently preceded by a period of drought, and, accordingly, the ground has a particularly high water absorptive capacity. The waste of water is a very important aspect of forest fire-fighting because a forest fire typically consumes the dry undergrowth (e.g., grass, foliage, and heather) and leads to individual crown fires which then unite. Since most forest fires occur in remote areas, aircraft are often employed. Fighting forest fires with aircraft involves the dropping of large quantities of water on the fire. However, by this method, as much as 80% of the load is wasted due to erosion before reaching the target, such that the aircraft must make a considerable number of trips in order to get the required amount of water on the fire to cool the vegetation to below its ignition point. Numerous attempts have been made to improve water as a fire extinguishing agent. The addition of substances which increase the viscosity of water have been described. These include cellulose derivatives, alginates or water-soluble synthetic polymers, such as polyacrylamides. Use has also been made of non-flammable mineral additives to the extinguishing water, e.g. water-soluble inorganic salts or water-insoluble materials such as bentonite or attapulgite [C. E. Hardy, Chemicals for Forest Fire Fighting, 3rd edition, Boston, 1977]. In special cases, such as when fighting forest fires, use has been made of mineral additives such as bentonite, attapulgite and water-soluble salts, as well as extinguishing water formulations mixed with alginates, which, after special preparation are frequently ejected from aircraft. Disadvantages associated with use of such additives include the high weight percentages of mineral additives generally required in order to achieve a sufficiently high level of thickening (e.g. 10 to 20% by weight); the corrosive action of certain salts such as sulfates or chlorides; and the possibility of undesired environmental influences, such as on fertilizing agents. Furthermore, the preparation of such thickened extinguishing agents generally requires special apparatus, particularly with respect to the mixing process. These agents generally cannot be applied using conventional fire extinguishing syringes and, such as in the case of alginate gums, do not adhere well to the target surfaces following spraying, particularly under the action of heat. Additionally, they frequently change their characteristics after even a short storage period and, after drying, sometimes leaving behind residues which are difficult to remove. Other fire-fighting compositions are known in the art, which are aimed at either decreasing water consumption or prevention of re-ignition of fire, or both. Suspensions for use in fire-fighting are known to include insoluble particles dispersed in a water-soluble polymer solution. Two types of such suspension are known: solid-liquid suspensions and gel-liquid suspensions.

U.S. Pat. No. 3,984,334, U.S. Pat. No. 4,037,665, U.S. Pat. No. 4,226,727, U.S. Pat. No. 4,234,432 and U.S. Pat. No. 5,861,106 teach solid-liquid suspensions.

U.S. Pat. No. 4,652,383 teaches a solid-liquid suspension composition which includes solid particles of vinyl polymer gelling agent (preferably a polyacrylate) and an ammonium compound suspended in a gelled liquid. Such a composition is not suitable for application using aerial equipment, and the polyacrylates are non-biodegradable materials.

U.S. Pat. No. 5,332,524 and U.S. Pat. No. 5,422,330 teach a fire-extinguishing solid-liquid suspension which includes water soluble poly(ethylene oxide) polymer for extinguishing Class A fire, and in association with fluoro-surfactant for extinguishing Class B fire. The composition is applied as a foam. The flow properties of the composition, the application mode and efficacy of extinguishing action are not disclosed.

U.S. Pat. No. 5,518,638 teaches the use of thickened synthetic amorphous silica in water as a fire extinguishing and protection agent which uses water-soluble polymers such as polyethylene glycols, polypropylene glycols, and their derivatives as thickening agent.

U.S. Pat. No. 4,971,728, U.S. Pat. No. 6,322,726; and U.S. Pat. No. 6,019,176 teach chemical concentrates which are adapted for dilution with water to produce long term fire suppressants specially adapted for aerial application to suppress wild land fires, using guar gum and its derivatives as thickeners and flow conditioners. Disadvantages of these compositions include the fact that the polysaccharides used are very expensive, and the preparation of the aqueous solutions is difficult, requiring specialized equipment. Gel-liquid compositions include those in which the gel phase comprises cross-linked synthetic polymers, known as super absorbent polymers (SAPs). Gels function as short-term fire retardants, since their effectiveness is due to their water content, such that upon evaporation of all the water, the gels are no longer effective.

U.S. Pat. No. 3,758,641, teaches the use of a water-swellable, water-insoluble polymer gel which includes a crosslinked polymer or crosslinked copolymer of acrylamide, an acrylate salt, vinyloxazolidinone, vinylpyrrolidinone, a methacrylate salt, or a styrenesulfonate salt, or a copolymer of styrene and maleic acid, which has been crosslinked by reaction with a glycol. The crosslinked gel is mixed with a water-soluble synthetic cationic polymer in order to promote adhesion to cellulosic material. The application mode of the composition is not specified.

U.S. Pat. No. 4,978,460 teaches the use of solid polymer particles of polyacrylate gel which is encased in a water-soluble release agent to extinguish fires. The time taken for these solid granular particles to expand upon absorption of water is longer than practical for the water to be retained in a fire hose. Additionally, in order to achieve the desired water absorption, 200 grams of gel per liter of water is required.

U.S. Pat. No. 5,190,110 teaches absorbent polymers which includes discrete particles of insoluble sodium polyacrylate dispersed in a water miscible medium to be incorporated into water.

U.S. Pat. No. 5,849,210 teaches a method of preventing a combustible object from burning by contacting the combustible object, before or during burning, with an aqueous composition which includes a water-insoluble superabsorbent polymer (SAP) and water. The above prior art gel-liquid compositions are not suitable for use against forest fires, since the compositions must be washed away after use, are not biodegradable, and do not prevent re-ignition of the fire after water evaporation. Another problem encountered in fighting a forest fire is an inability to precisely determine which objects, or areas, have been sprayed and which have not. This is an especially difficult problem encountered in aerial fighting of forest fires. Effective fire-fighting requires that all objects or areas of interest are sprayed, while minimizing double spraying of some objects or areas.

U.S. Pat. No. 7,670,513 teaches a fire-fighting composition which includes a superabsorbent polymer (polyacrylate sodium salt); a soluble or dispersible colorant; an additional opacifying agent; and water. The colorant is selected such that its color is in contrast to the color of the combustible objects being treated. Due to the solid, granular nature of the absorbent polymer particles used in prior art fire-fighting compositions, it is difficult, if not impossible, to use these polymers in certain applications. For example, if a natural source of water, such as a creek or a river, is to be used as the water source, it is impossible to pre-mix the polymer and batch add it to the water source, as necessary in traditional applications, in order to draw it off to use to combat fires. By pouring the additive-into a stream or river, most of the additive will simply flow past the point of suction of the water for use in combating fires. Because of the particulate nature of the known water-absorbent polymers used in fire-fighting compositions, use of such polymers in standard fire-fighting hoses with standard equipment is nearly impossible. The solid nature of the polymers promotes particle agglomeration and subsequent blockage of the flow of the water. Alternatively, it is also sometimes necessary to provide pumps and spray nozzles adapted for handling such solid granular particles which U.S. Pat. No. 3,758,641 teaches. Some of the disadvantages associated with use of SAP in gel-liquid fire-fighting compositions can be overcome by the use of emulsions.

U.S. Pat. No. 6,296,781 teaches a fire extinguishing emulsion which contains emollient; emulsifier; dispersant; oxygen depleting substance; radical scavenger; and oxygen competitor, in water acting as a carrier.

U.S. Pat. No. 5,989,446 and U.S. Pat. No. 6,245,252 teach a water additive which contains a cross-linked, water-swellable polymer additive in a water/oil emulsion produced by an inverse phase polymerization reaction to be added to the fire-fighting water. The polymer is a co-polymer of acrylamide and acrylic acid derivatives. Such formulations may include chemical combinations that are dangerous to plants, and that various compounds disposed in the formulations may be substantially non-degradable or insufficiently degradable, particularly at ambient conditions. The formulations do not contain a long term flame retardant, such that the underlying vegetation may be disadvantageously re-ignited after the water is evaporated.

U.S. Pat. No. 7,033,526 teaches a firefighting composition in the form of a gel containing urea or a urea derivative which retains water and releases CO.sub.2 upon heating. The composition also includes a rheology modifier. Disadvantages of these compositions are similar to those of the above-described emulsions.

U.S. Pat. No. 7,189,337 teaches a fire-fighting additive which has a cross-linked, water-swellable polymer and a vegetable oil dispersion. The additive is added to fire-fighting water to form a gel. The use of such an additive may have the same disadvantages as the use of various traditional synthetic polymers.

Large-scale forest fires are prevalent throughout the Midwest and Western states, and significant sums are spent on fire-fighting equipment. The conventional approach is aerial fire-fighting using fixed-wing aircraft and helicopters to drop chemicals such as water, foams, gels, or other specially formulated fire retardants. These chemicals are dropped from large air tankers with tanks that can be filled on the ground at an air tanker base. It has been reported that “The U.S. Forest Service and Bureau of Land Management own, tease, or contract for nearly 1,000 aircraft each fire season, with annual expenditures in excess of US$250 million in recent years. Borate salts were used in the past to fight wildfires but were found to sterilize the soil, kill animals, and are now prohibited. Newer retardants use ammonium sulfate or ammonium polyphosphate with a thickener. These are less toxic but still not environmentally friendly. Brand names of tire retardants for aerial application include Fire-Trol and Phos-Chek. In addition to toxicity, there are serious questions about the effectiveness of air-tankers. The state of Victoria, Australia tested the effectiveness of a fleet of DC-10 Air Tankers during their wildfire season in 2009-2010, and concluded that these aircraft would not be effective in suppressing bushfires, especially in areas where the forest meets communities of relatively high populations. This was partly because the drop cloud released by the DC-10 is not uniform, but has thick and thin sections which leave areas on the ground with insufficient coverage. In addition, one drop impacted an Eucalyptus forest with such force that it broke off a number of trees with diameters of 4 to 10 inches. While the researchers did not have adequate equipment to accurately determine the drop height, it was thought that the aircraft was unintentionally flying too low and the retardant was still moving forward, rather than straight down, when it impacted the forest. Optimal dispersion without damage occurs when the drop is made straight down at 100-200 feet above the tree line, and this is difficult in an airplane. The government was also concerned that such drops have the potential to cause serious injury should the load fall on a person. Rather than flying low and at slower speeds, an aircraft can drop an explosive payload from a higher altitude, and the concept of a fire extinguishing bomb for extinguishing forest fires is well known.

U.S. Pat. No. 4,344,489 teaches a forest fire extinguishing projectile filled with an inert gas under pressure which is dropped into a fire and, upon impact, automatically disperses the gas.

U.S. Pat. No. 2,703,527 teaches a similar fire-extinguishing bomb filled with fluid.

U.S. Pat. No. 6,318,473 teaches a fire extinguishing system including a sealed and explodable container with an explosive trigger for opening the sealed and explodable container to release the fire extinguishing agents. In use, the sealed and explodable container is placed at a base of the fire either by air dropping the container to the ground or by placing the container in the path of the fire, whereupon the container is opened with either an explosive device or by impact.

U.S. Pat. No. 4,964,469 teaches a device which, upon impact, will broadcast a dry material such as fire-suppressing chemicals by explosive force. The device includes an explosive charge within a frangible rigid-wall container, a dry powder payload, and a fuse cord that ignites upon impact.

U.S. Pat. No. 4,285,403 teaches an explosive fire extinguisher that is designed to be dropped from an aircraft into fires such as forest fires. The device may be shock triggered on impact.

U.S. Pat. No. 7,089,862 teaches a water pod that ruptures when dropped from an aircraft. The water pod may have a barometric activated explosive that is activated at a predetermined altitude. Most of these prior art attempts rely on ground impact to release the fire retardant upon impact. Only the '862 patent to Vasquez suggests a water bomb with a timed-detonation or barometric activated explosive that is activated at a predetermined delay or altitude, but no design details are given, it is no easy task to design a barometric-activated fire-extinguishing bomb. Consequently, there remains a need for an altitude-activated fire-extinguishing bomb that can be pre-programmed to explode at anywhere between 2-200 feet above the tree line, detonating with extreme accuracy and reliability at a preset altitude, and thereby disperse a fire suppressant or fire retardant fire retardant uniformly over a consistent area. There is a further need for an altitude-activated fire-extinguishing bomb as above that is substantially biodegradable such that after detonation it presents no environmental problem, or one that can be readily recovered by a GPS locator and reused, thereby increasing economy and reducing environmental concerns.

U.S. Pat. No. 9,036,942 teaches a projectile that can be equipped with a camera and be configured to detonate after receiving a command to detonate. After the projectile is thrown the camera can capture images. These images can be sent by way of the physical link to the handheld device. The handheld device can display the images. A user of the handheld device can view the images and determine if the projectile should detonate based on the images. In a combat setting, a warfighter can identify an enemy target. This enemy target can be considered a threat to the warfighter and in view of this threat the warfighter can make a decision to attempt to eliminate the threat. Various weapons can be used to eliminate the threat. A shrapnel grenade can be used to eliminate the threat. The shrapnel grenade can have a pin in place that stops the shrapnel grenade from activating. When the pin is pulled, a timer of the shrapnel grenade can activate unless the timer is manually paused or the pin is replaced. The warfighter can throw the shrapnel grenade and the shrapnel grenade can detonate after the timer expires. The goal can be for the timer to expire when the shrapnel grenade reaches the threat such that the threat is subjected to the shrapnel.

U.S. Patent Publication No. 2014/0158010 teaches a remote firing system for remotely detonating explosive charges which includes features that provide safety and efficiency improvements. These features include safety communication among multiple remote devices and multiple controller devices, a polling functionality permitting rapid deployment of system devices, electronic key systems, programmable remote devices for easy replacement of failing remote devices, and an event history log for the remote devices for efficient diagnostic evaluation. Blasting technologies have expedited mining operations, such as surface mining and subterranean mining, by allowing the strategic and methodic placement of charges within the blasting site. Despite this, blasting technologies still carry safety risks that should be minimized. Effective blasting requires not only well-placed detonators, but also timed detonation of the charges in a predetermined sequence. Accurate and precise control and firing of the detonators is important for effective and efficient blasting. The more precise and accurate control of the detonators also leads to an increase in safety of the system overall. Thus, it is desirable to have a blasting system that effectively and efficiently controls the detonation of various types of charges while simultaneously increasing the overall safety of the system.

Every year millions of dollars-worth of timber land, recreational facilities, homes and other natural resources are lost due to fire. Many of these fires take several days or even weeks to contain. Realizing that one way to stop the loss is to prevent the fires from occurring, great efforts are made and much time is spent in educating the public so that the fires will not occur. However, no matter how much care is taken, there is no way to stop forest fires from occurring. Therefore, the next question is whether the present methods for fighting forest fires are adequate. Unfortunately, the answer seems to be “no.” When a fire breaks out in one of the forests, many crews of men are sent in to try and contain it, but they are not given effective tools in order to achieve their task. The men generally try to stop the fire by digging holes and grading roads and just plain hoping that the fire will not jump across the fireline. For reasons discussed below, fire retardant sprays and powders that are presently being used are generally not effective in stopping the travel of the fire. The conditions necessary for the existence of fire are the presence of a combustible substance, a temperature high enough to cause or support combustion (called the kindling temperature), and the presence of enough oxygen (usually provided by the air) to enable combustion to continue. Therefore, fire-fighting consists of removing one or more of these. It is known in the art to have water supplied to a fire to cool the fire below combustion temperatures. It is also known to involve chemicals other than water, especially useful for fires involving flammable liquids, particularly when water may be dangerous. A variety of chemicals may be added to water to improve its ability to extinguish fires. Wetting agents added to water can reduce its surface tension. This makes the water more penetrating and facilitates the formation of small drops necessary for rapid heat absorption. Also, by adding foam-producing chemicals and liquids to water, a fire-blanketing foam is produced which is used to extinguish fires in combustible liquids, such as oil, petroleum, and tar, and for fighting fires at airports, refineries, and petroleum distribution facilities chemical additive can also expand the volume of foam, perhaps by 1000 times. This high-expansion foam-water solution is useful in fighting fires in basements and other difficult-to-reach areas because, the fire can be smothered quickly with relatively little water damage. It is also known to use chemicals, such as carbon dioxide, to displace needed oxygen from a fire. Carbon dioxide is used particularly for extinguishing fires because it does not burn and does not support ordinary combustion. It is also known to have various equipment to deliver water or other chemicals to the fire. With the development of the internal-combustion engine early in the Twentieth Century, Fire Department pumpers became motorized. Because of problems in adapting geared rotary gasoline engines to pumps, the first gasoline-powered engines had two motors, one to drive the pump and the other to propel the vehicle. The pumps were originally of the piston or reciprocating type, but these were gradually replaced by rotary pumps and finally by centrifugal pumps, used by most modern pumpers. At the same time, the pumper acquired its main characteristics: a powerful pump that can supply water in a large range of volumes and pressures; several thousand feet of fire hose, with short lengths of large-diameter hose for attachment to hydrants; and a water tank for the initial attack on a fire while fire fighters connect the pump to hydrants, and for areas where no water supply is available. In rural areas, pumpers carry suction hose to draw water from rivers and ponds. Various nozzles are capable of projecting solid, heavy streams of water, curtains of spray, or fog. Fire trucks carry a selection of nozzles, which are used according to the amount of heat that must be absorbed. Nozzles can apply water in the form of streams, spray, or fog at rates of flow between 57 liters (15 gal) to more than 380 liters (more than 100 gal) per minute. Straight streams of water have greater reach and penetration, but fog absorbs heat more quickly because the water droplets present a greater surface area and distribute the water more widely. Fog nozzles may be used to disperse vapors from flammable liquids, although foam is generally used to extinguish fires in flammable liquids. Methods of fighting forest fires are necessarily different than fighting areas in developed areas, where access and water supply are generally less of a problem. Forest fires, often called wildland fires, are spread by the transfer of heat, in this case to grass, brush, shrubs, and trees. Firefighting crews are trained and organized to handle fires covering large areas. They establish incident command posts, commissaries, and supply depots. Two-way radios are used to control operations, and airplanes are employed to drop supplies as well as chemicals. Helicopters serve as command posts and transport fire fighters and their equipment to areas that cannot be reached quickly on the ground. Some severe wildfires have required more than 10,000 fire fighters to be engaged at the same time. Various forest fire-fighting techniques are known in the art. These techniques require placing the fire-fighting chemicals onto the fire from above. This may be difficult and may be inefficient. This is especially true if access is limited or difficult. In a forest fire, an aircraft may be used to drop chemicals onto the fire from above, but such chemicals must be designed to penetrate extremely hot conditions before reaching a location at which they can be effective. This may be inefficient. Furthermore, some of the chemicals may become dispersed in trees or other objects that are well above ground level thereby diminishing the amount of fire-fighting chemical reaching the ground. Aircraft such as the C-130 presently used for fire-fighting by agencies such as the U.S. Forest Service are outfitted with liquid fire retardant dispersal systems including a liquid retardant reservoir, compressed air tanks, air compressor, discharge tube and nozzles, and related equipment all mounted on movable pallets. The systems are designed to perform multiple individual discharges each of several hundred gallons over a 4 to 5 second period, in a single flight, or to discharge the entire contents in a single burst. The systems are generally large and heavy, have power requirements that severely tax the available power supply aboard an aircraft, and potential electromagnetic interference (EMI) from the equipment that can be disruptive to the aircraft avionics. Because it is frequently difficult to extinguish a forest fire by attacking it directly, the principal effort of forest fire fighters is often directed toward controlling its spread by creating a gap, or firebreak, across which fire cannot move. Firebreaks are made, and the fire crews attempt to stop the fire by several methods: trenching, direct attack with hose streams, the aforementioned aerial dispersing, spraying of fire-retarding chemicals, and controlled back-burning. As much as possible, advantage is taken of streams, open areas, and other natural obstacles when establishing a firebreak. Wide firebreaks may be dug with plows and bulldozers. The sides of the firebreaks are soaked with water or chemicals to slow the combustion process. Some parts of the fire may be allowed to burn themselves out. Fire-fighting crews must be alert to prevent outbreaks of fire on the unburned side of the firebreaks. Furthermore, reflash, or re-ignition of an extinguished area may still occur if conditions are right. This presents a serious drawback in fighting the fire, and also presents a serious danger to crews. Chemicals applied from above may permit such conditions to occur. It is clear that fire-fighting, both in wilderness conditions and in developed areas, still lacks a capability of an immediate response safe to the fire fighter because of an inability to immediately deliver fire retarding chemicals to the fire in an efficient manner and in a manner that will prevent re-flash of the fire.

Chemical flame retardants disposed inside the folded cover material. The chemicals used are brominated polymeric acrylic or vinyl acetate binders like the TexFRon series from ICL-IP (see http://www.dsbg.com/ in “Textile Applications”, Bareket, Y. (2005). To B. G. Polymers), PCT Patent Appl., WO 05/070980 and as well as other non-polymeric flame retardant products including poly brominated aromatic and aliphatic compounds such as FR 9020, FR 720, as well as phosphorous containing insoluble salts such as ammonium polyphosphates and others. The Flame retardant (FR) may be dispersed in water or in natural or synthetic polymers including poly acrylates, poly acetates, poly-sacharides, starches and modified starches, gums, saps and polypeptides. Co-solvents may s be used to prepare the dispersions including primary secondary and tertiary alcohols, esters, linear and cyclic hydrocarbons, halogenated hydrocarbons and phenyl type solvents. The aqueous and non aqueous dispersions may also include polymeric adhesives intended to promote adhesion of the formulation to plant surfaces including polyamide, polyester, polyol, and polyolefin. Sequential steps of preparing the formulation: a) TexFRon or other fire retardant is diluted in water or solvents to a range of 50 to 5% solids; b) Non ionic wetting agent is added at a concentration range of 0.1 to 5% by weight. c) Thickening and adhesion agents as detailed above are added as needed to obtain a viscosity range of 20 to 2,000 cps. Other additives (synergists, pigments, lubricants, adhesives, etc.) are added as needed d) formulation is applied to cover material surfaces at wet pick up ranging from 1 to 80%. based on estimated substrate weight (substrate being the cover material) e) Coating is allowed to air dry for a minimum of 2 hrs. Synergists include antimony, tin, boron, zinc, aluminum oxides and salts and insoluble phosphorous containing salts include ammonium polyphosphates. Synergists are added at a ratio ranging from 1:1 to 1:20 synergist to fire retardant agent. The novelty of the formulation is obtaining good flame retardancy once spilled on the foliage and at the same time sufficient add-on (1 to 80% on dry weight of cover) of the fire retardant agent to impart flame retardancy that will prevent ignition or re ignition as the adjoining flame front reaches the treated area

The inventors hereby incorporate the above-referenced patent into their specification.

### SUMMARY OF THE INVENTION

The present invention is generally an intelligent method of fighting a forest or brush fire in a remote area and includes the steps of targeting the remote area by means of an aerial surveillance device and generating a map of the forest or brush fire.

In a first aspect of the present invention the method also includes the step of delivering a plurality of containers to the remote area with each container containing a fire retardant material and an explosive device and having a GPS locating device, a position transmitting device and a remote detonating device electronically coupled to the explosive device.

In a second aspect of the present invention the method further includes the steps of locating the position of each container, selecting according to a plan which of the containers are to be selected to be detonated and remotely detonating the selected containers. The forest or brush fire can be either extinguished or contained in an intelligent manner.

In a third of the present invention an individual generates the plan according to which of said containers are to be selected to be detonated in order to maximize effectiveness of said intelligent method.

Other aspects and many of the attendant advantages will be more readily appreciated as the same becomes better understood by reference to the following detailed description and considered in connection with the accompanying drawing in which like reference symbols designate like parts throughout the figures.

### DESCRIPTION OF THE DRAWINGS

FIG. 1 is a perspective view of a housing included in a fire-fighting system according to U.S. Pat. No. 7,261,165.

FIG. 2 is a sectional view taken along line 2-2 of FIG. 1 showing the internal structure of the housing shown in FIG. 1.

FIG. 3 is a perspective front view of a barometric-activated fire-extinguishing bomb according to U.S. Pat. No. 8,746,355.

FIG. 4 is a side cross-section of the barometric-activated fire-extinguishing bomb of FIG. 4 which has a programmable controller.

FIG. 5 is a block diagram of the programmable controller of FIG. 4.

FIG. 6 is a first schematic drawing of an aircraft with multiple grenade launching capability flying over a forest or bush fire front showing designated target areas for the grenades according to the present invention.

FIG. 7 is a second schematic drawing of an aircraft with multiple grenade launching capability flying over a forest or bush fire front showing designated target areas for the grenades according to the present invention.

FIG. 8 is a perspective front view of one of the grenades of FIG. 6.

FIG. 9 is a side cross-section of the grenade of FIG. 8.

FIG. 10 is a schematic drawing of one of the grenades of FIG. 6 which has an explosive charge detonator, a flame retardant charge, a remote detonation device, a GPS device and a position transmitter.

FIG. 11 is a schematic drawing of the block diagram of remote detonating system according to the present invention.

### DESCRIPTION OF THE PREFERRED EMBODIMENT

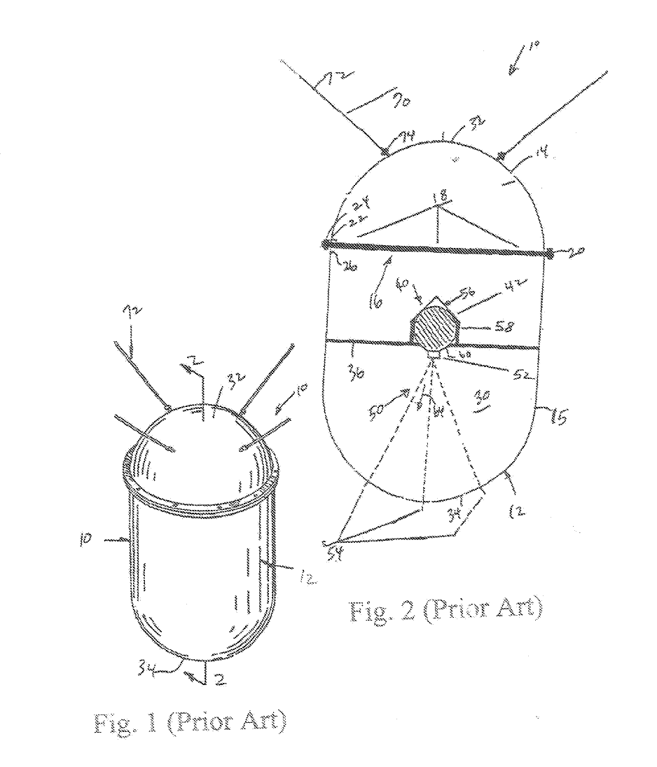

Referring to FIG. 1 in conjunction with FIG. 2 a unit 10 for fighting forest fires. The unit 10 is carried to a target location on an airplane or on a helicopter and is then dropped into the fire. The unit 10 will fall through the fire and any trees or the like that may be located in the drop zone and impact the ground. Upon impact the unit 10 will open and disperse fire-smothering chemicals on the ground. This ground-located dispersion will smother the fire at its source and will remain in place even after the fire is extinguished. This feature of the unit 10 will reduce, if not totally eliminate, re-ignition of an extinguished fire. Brush, trees or the like are not likely to interfere with the dropping of the unit 10 so accuracy will be enhanced.

Referring still to FIG. 1 in conjunction with FIG. 2 the unit 10 includes a housing unit 12 which can be formed of either stainless steel or fiberglass. The housing unit 12 includes a first part 14 and a second part 15 and a coupling element 16 releasably coupling the first part to the second part. The coupling element 16 can include a bolt 18 having a head 20 and a threaded end 22 to which a nut 24 is threadably attached. The two parts 14 and 15 of the housing unit 12 can be separated from each other after the coupling element 16 is released so chemicals can be placed in the housing unit 12. An O-ring 26 can be interposed between the two parts of the housing unit 12 to ensure proper sealing of the housing unit. The housing unit 10 further includes a hollow interior volume 30 which is adapted to contain a fire-smothering chemical, a first end 32, a second end 34 and a support structure 36 in interior volume 30. The support structure 36 can be a shelf-like element mounted on the housing unit 12. An explosive unit 40 is mounted on the housing unit and includes an explosive charge 42 supported on support structure 36 inside the hollow interior volume. The exact nature of the explosive charge is not important to the instant invention and those skilled in the art will understand the type and size of the explosive charge based on the teaching of the present disclosure. Accordingly, the details of explosive charge 42 will not be presented. An explosive charge detonator system 50 includes a detonator cap 52 on the explosive charge and a plurality of spaced apart detonator pins 54 located on second end 34 of the housing unit. Each of the detonator pins is connected to the detonator cap to ignite the detonator cap upon impact with the ground. The detonator pins being spaced apart from each other so the explosion can be initiated upon any section of second end 34 impacting the ground. A housing 56 is located adjacent to the explosive charge and has walls 58 that enclose the explosive charge in all areas except one. The open area is indicated in FIG. 2 as area 60. Area 60 is located to direct an explosion associated with the explosive charge toward the second end of the housing unit upon explosion of the explosive charge as indicated by arrow 64. The explosion associated with the explosive charge causes the first part of the housing unit to separate from the second part of the housing unit and causes the fire-smothering chemical located inside the hollow interior of the housing unit to be dispensed and dispersed from the thus opened housing unit. A support system 70 is located on first end 32 of the housing unit. Support system 70 includes airbrakes 72 releasably coupled to the housing unit by bolts 74 or the like. In use, the unit 10 is suspended from an aircraft and transported to a fire site. Once at a target site, the unit 10 is released from the aircraft and drops to the ground. The unit 10 will fall through trees and brush so it will contact the ground. The air brake system ensures that the housing unit will fall in an orientation that ensures second end 34 striking the ground. As soon as second end 34 of the unit 10, one or more of the detonator pins will cause explosive charge 42 to detonate thereby separating the two parts of the housing unit from each other and dispersing any fire-smothering chemical stored inside the housing unit over the target area. Filling housing unit 10 and locating the explosive charge inside the housing unit is facilitated by the separable nature of the two parts of the housing unit

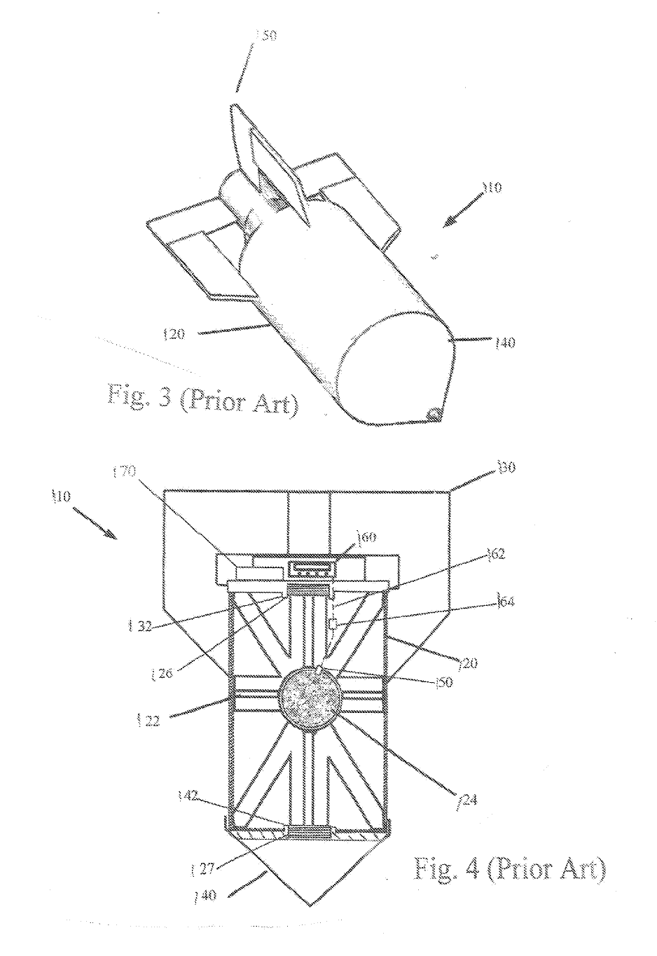

Referring to FIG. 3 in conjunction with FIG. 4 an altitude-activated fire-extinguishing bomb 110 can be pre-programmed to explode anywhere within a range of 2-200 feet above the tree line, using a high-speed laser or barometric-altimeter detonation with reference to backup GPS data to ensure failsafe detonation. Upon mid-air detonation the fire-extinguishing bomb expels a fire suppressant or retardant, a dry environmentally-friendly fire-retardant powder with no toxicity and fertilizer properties over a consistently-uniform area. The fire-extinguishing bomb payload may alternately be any suitable dry chemical agent such as Williams' PKW which is a potassium bicarbonate based agent, or a liquid such as either Halotron or water. Guar Guar gum can be added so the liquid will stick to leaves. The device can be used for both fire suppression and fire retarding. The altitude-activated fire-extinguishing bomb is substantially biodegradable cardboard and after detonation it presents no environmental problem. Alternatively, it can be readily recovered by a GPS locator and reused, thereby increasing economy and reducing environmental concerns. The bomb 110 generally includes a hollow cylindrical canister 120 formed of rupturable material, preferably corrugated cardboard or thin plastic. The cylindrical canister 120 is topped by an aerodynamic weighted tip 140 at one end, and a tail section 130 at the other end, both of which maintain a vertical trajectory. A programmable controller 160 is panel-mounted exteriorly on the tail section 130 or in some other place. The bomb 110 may be dropped from a cargo airplane at speed or a stationery helicopter right over the target. The bomb 110 is envisioned as being recoverable and reusable, or non-recoverable, depending on preference. In the latter case corrugated cardboard is preferred for its biodegradability, and with a laminated internal film liner if a liquid suppressant/retardant is to be used. For a recoverable/reusable variation, it is possible to use a conventional one-piece seamless 500 gallon (or larger or smaller) chemical storage drum rotationally-molded of UV-resistant low density polyethylene, with ¼″ thick translucent wall for easy product level viewing. The polyethylene may be molded or score with seams to help ensure uniform rupture. In both cases dimensions are a matter of design choice, though exemplary dimensions are 46½″ wide by 75″ tall, with full 46″ removable fill caps at each end. One skilled in the art will understand that canister 20 may be formed of any other suitable rupturable material including high density plastic, acrylic, high or low density plastic including PETG plastic, wood, fiberglass or any other suitable material.

Referring to FIG. 4 an internal framework 122 is inserted into the canister 120. The internal framework 122 is a suitable three-dimensional structure for supporting and withstanding an explosive charge 124 at the center of canister 120 while it is filled with suppressant/retardant. The illustrated framework 122 includes a series of ½′ thick struts converging from the center of canister 120 outward to its inner walls, and leaving an open area at its center. The framework 122 is made of Kevlar or other substantially explosion-proof material, and the struts are as thin (approximately ½″) but wide (6-10″) to securely cradle the explosive charge 124 without obstructing or absorbing the blast. The framework 122 has screw-threaded mounting collars 126 and 127 at both ends both oriented along the axis of the canister 120 for mounting the cone-tip 140 and tail section 130. The cone tip 140 is weighted, water filled, and may be a rupturable hollow closed cone with overhanging lip that fits over the canister 120, and attaches centrally thereto by screw-insertion of a screw-receptacle 142 onto screw-threaded mounting collar 127 of framework 122. The cone tip 140 is purely for weighting/aerodynamics in order to maintain a vertical orientation during free fall, and also serves to sandwich and center internal framework 122 within canister 120. Similarly, tail section 130 is a screw-on cap bearing a threaded collar 132 that attaches onto screw-threaded mounting collar 126 of framework 122. The tail section 130 is also for aerodynamics and supports three or four radially-mounted foils around the periphery of the canister 120 for maintaining a vertical line in flight. The tails section 130 also serves to sandwich and center internal framework 122 within canister 120. In addition, tail section 130 provides a mounting for the controller 160 which is tucked in behind the canister 120. Programmable controller 160 has an on/off switch that serves as an activation control.

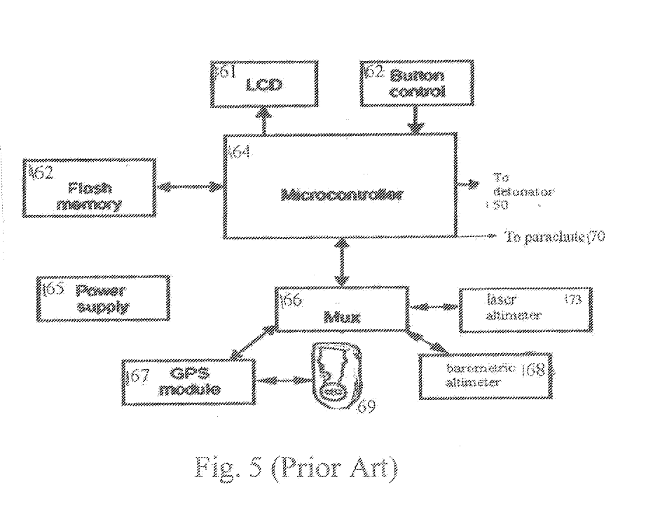

Referring to FIG. 5 in conjunction with FIG. 4 the controller 160 is connectable by internal wires 162 to a detonator 150 connected to an explosive charge 24 at the center of canister 120. The internal wires 162 are internally coupled by connector 164 so that the internal connection can be made prior to screw-coupling the tail section 30 to canister 120. One skilled in the art should understand that the internal wires 162 may be integrally molded into framework 122, and connector 164 may be anywhere along their length (otherwise than exactly as shown). Alternatively, wires 162 may be replaced with wireless capability such as radio frequency, Bluetooth or other known wireless protocols. With the framework 122 inserted and cone-tip 140 mounted, the explosive charge 124 is inserted at the center of canister 120. The explosive charge 124 is packed with C4 or other suitable primary high explosive charge and has an integral detonator 150 inserted therein, C4 includes explosives, plastic binder, plasticizer and trace chemicals. The explosive is RDX, cyclonite or cyclo-tri-methylene tri-nitramine, which makes up around 91% of C4 by weight. The size of explosive charge 124 is approximately one M112 demolition charge, which is approximately 33 cubic inches. C4 is very stable and insensitive to most physical shocks, and will not explode even when lit on fire. When the charge is detonated, the explosive is converted into gas. The gas exerts pressure in the form of a high velocity shock wave, which fragments the frangible canister 120 and disperses the MAP powder over a wide area. The detonator 150 is a commercially-available electric igniter. The detonator 150 may be attached to and wired through framework 122 to programmable controller 160, and connector 164 may be provided anywhere along the wiring. Alternatively, detonator 50 may be in wireless communication with controller 160 via radio frequency, Bluetooth or other known wireless protocol. The programmable controller 60 is a program able-altitude detonation control module with on-board or remote redundant altitude sensing circuit utilizing a primary altimeter and a GPS-based altimeter is redundant backup. The primary altimeter may be a laser line-of-sight distance measuring device, or a barometric pressure-measuring device as will be described. Once set to explode at some variable distance above tree level, either preferably 2-200 feet above the tree line or about 100-400 feet total, the programmable controller 160 will automatically detonate the explosive charge 124 at that precise altitude +/−10 feet. If the higher-accuracy barometric or laser distance detector altimeter 173 fails, the GPS-based altimeter 167 serves as a fail-safe backup for detonation.

Referring to FIG. 5 the programmable controller 160 includes a conventional microcontroller 172 with peripheral flash memory 163, LCD display 161, control interface 171, all powered by a battery power supply 165. An “arm/disarm” control or ON/OFF switch applies power to the circuitry. If an “arm/disarm” control is provided, it may be a delayed-activation switch to ensure that the bomb 110 is falling before applying power to the circuitry. The switch may be an air/wind speed sensor that activates the circuitry when the bomb attains a predetermined airspeed. This way, if the wind speed hits sixty miles per hour the switch then activates the circuitry. Any other suitable type of switch may be used. The microcontroller 172 is pre-programmed to alternately poll through a multiplexer 166 a GPS module 167 for satellite position coordinates and a barometric altimeter 168 for barometric altitude data. The barometric altimeter 168 is a high-accuracy altitude-sensing device as will be described and provides the primary altitude detonation data used by microcontroller 172 in activating the detonator 150. As a failsafe the microcontroller 172 also periodically polls the GPS module 167 to confirm the data from the barometric altimeter 168, compares the data, and if the latter fails for any reasons the microcontroller 172 will as a failsafe rely on the GPS module 167 to detonate at a safe level. In accordance with the present invention, the microcontroller 172 polls both altitude data sources, the GPS module 167 and barometric altimeter 168, and keeps a dual-archive of both data streams in flash memory 163, monitoring both datasets to ensure a continuous log of decreasing altitude (as the bomb falls). With preference to the high-accuracy barometric altimeter 168, if the altitude dataset is interrupted for any reason microcontroller 172 will abandon its reliance and rely instead on the GPS data, ensuring detonation at a safe pre-programmed level. Logically, the microcontroller 172 is programmed to detonate at a predetermined level, approximately 100-200 feet above tree level or 400-500 feet above ground level, and if the barometric altimeter 168 or laser distance detector fails, will default to detonate at 300-400 feet above ground level as measured by GPS module 167. Upon detonation the microcontroller 172 emits a signal to the detonator 150 which explodes the C4 charge 124. At programmable time shortly before, simultaneous, or shortly after detonation the microcontroller 172 emits a signal to a deployable parachute 170, and so as detonator 160 explodes the C4 charge 124, a parachute 170 attached to the tail section 130 unfurls. Parachute 170 is a conventional parachute except that it is fabricated from fireproof fabric. The exploding C4 charge 124 is calculated to blow apart the canister 120 and distribute its contents in a uniform pattern, which contents continue to disperse as they fall. Upon detonation the cone tip 140, tail section 130, ballistic internal framework 122, programmable controller 160 remain intact and fall softly to earth by parachute 170. The GPS module 167 is connected to a conventional personal locator 169 also mounted in programmable controller 160 which emits a satellite beacon containing the GPS coordinates for easy recovery of the component parts.

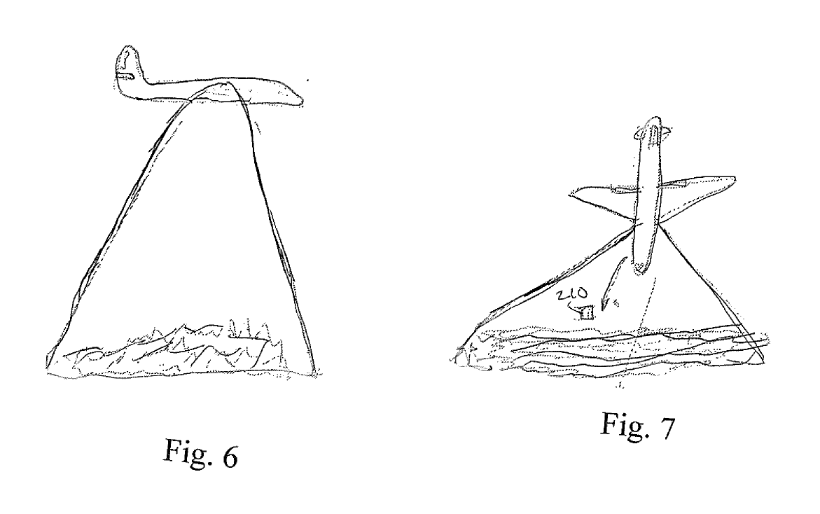

Referring to FIG. 6 in conjunction with FIG. 7 an intelligent method of fighting a forest or brush fire in a remote area begins with the steps of targeting the remote area by means of an aerial surveillance device from an aircraft and then generating a map of the forest or brush fire.

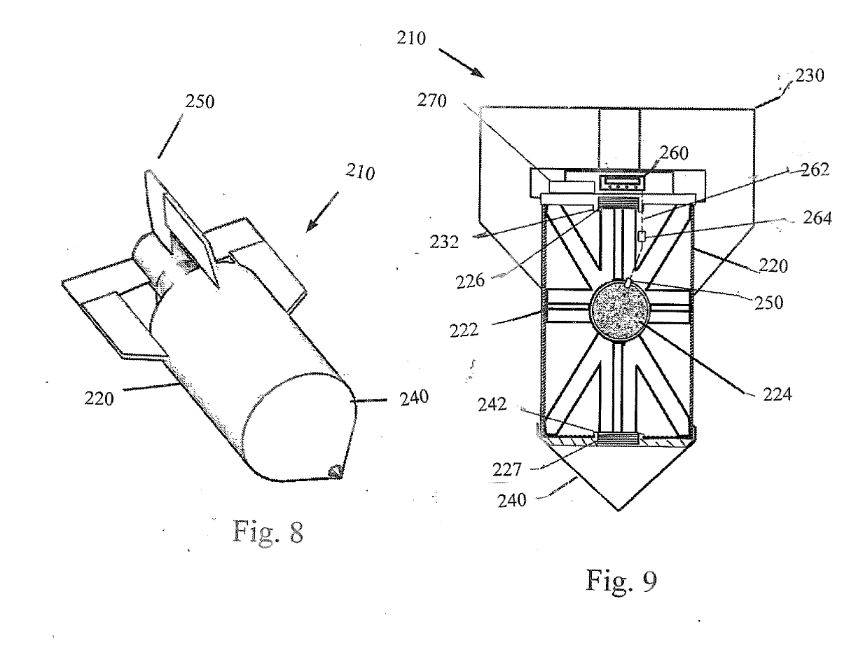

Referring to FIG. 8 the intelligent method of fighting a forest or brush fire in a remote area includes the step of delivering a plurality of containers to the remote area from either an aircraft or a ground vehicle.

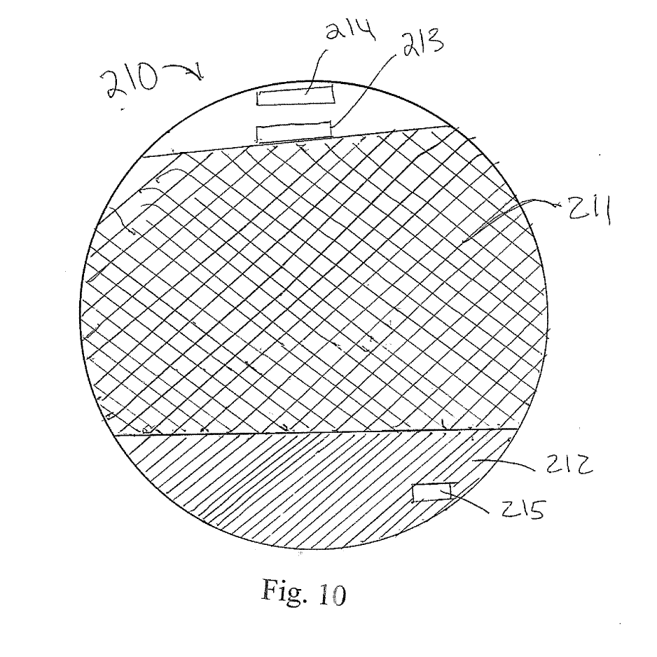

Referring to FIG. 9 in conjunction with FIG. 10 each container 210 contains a fire retardant material 211 and an explosive device 212, a GPS locating device 213, a position transmitting device 214 and a remote detonating device 215 electronically coupled to the explosive device 212.

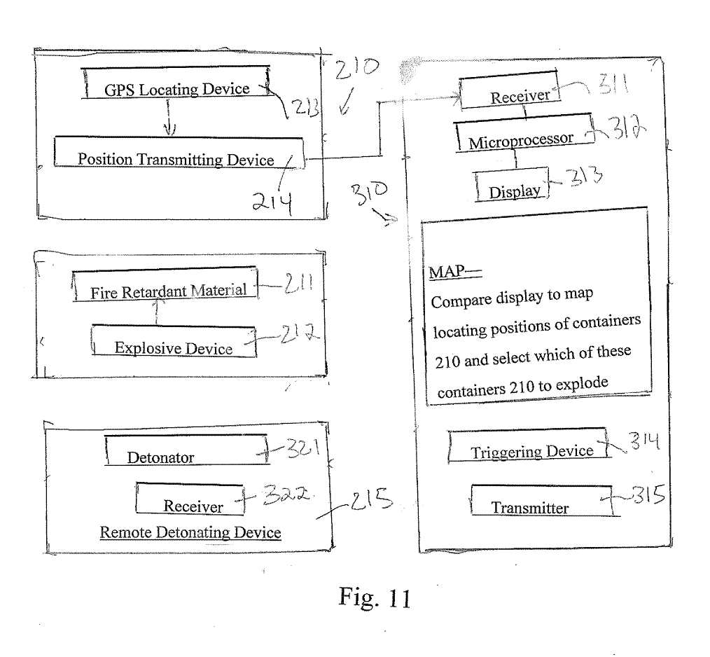

Still referring to FIG. 11 in conjunction with FIG. 9 and FIG. 10 the intelligent method of fighting a forest or brush fire in a remote area also includes the steps of locating the position of each container 210, selecting according to a plan which of the containers are to be detonated and remotely detonating the selected containers 210 so that the forest or brush fire can be either extinguished or contained in an intelligent manner. An individual generates the plan according to which said containers are to be detonated in order to maximize effectiveness of said intelligent method. The individual uses a remote detonating system 310 to remotely detonate the selected containers 210 from either the aircraft or the ground vehicle.

Referring to FIG. 11 the remote detonating system 310 includes a receiver 311, a microprocessor 312 with a display 313 and a triggering device 314 and a transmitter 315. The receiver 311 is electronically coupled to the GPS locating device 213 and the position transmitting device 214 and to the microprocessor 312. The individual is able to view the location of each grenade 210 on the map and is then able to select which of the grenades 210 are to be detonated. The individual uses the triggering device 314 to send a trigger signal via the transmitter 315 to the remote detonating system 215. The remote detonating system also includes a plurality of detonators 321 each of which is coupled to one of the plurality of grenades 220. Each detonator 321 includes a receiver 322 and a detonating device 323. The receiver 322 is electronically coupled to the detonating device 323 and activates the detonating device 323 in response from a signal from transmitter 315 of the remote detonating system 310.

From the foregoing it can be seen that an intelligent method of fighting a forest or brush fire in a remote area has been described. It should be noted that the sketches are not drawn to scale and that distances of and between the figures are not to be considered significant.

Accordingly, it is intended that the foregoing disclosure and showing made in the drawing shall be considered only as an illustration of the principle of the present invention.

What is claimed is:

1. An intelligent method of fighting a forest or brush fire in a remote area comprising the steps of:
a. targeting the remote area by means of an aerial surveillance device and generating a map of the forest or brush fire;
b. delivering a plurality of containers to the remote area wherein each of said containers contains a fire retardant material and an explosive device and wherein each of said containers has a GPS locating device. a position transmitting device and a remote detonating device electronically coupled to said explosive device;
c. locating the position of each of said containers on said map and selecting according a plan to which of said containers are to be detonated whereby an individual generates the plan according to which of said containers are to be selected to be detonated in order to maximize effectiveness of said intelligent method; and
d. remotely detonating said selected containers whereby the forest or brush fire can be either extinguished or contained in an intelligent manner.
